(19) United States
(12) Patent Application Publication
(10) Pub. No.: US 2023/0136627 A1
(43) Pub. Date: May 4, 2023

(54) FUSE SEATS FOR ENCLOSED FUSES

(71) Applicant: Eaton Intelligent Power Limited, Dublin 4 (IE)

(72) Inventors: Somnath Janaba Devarde, Maharashtra (IN); Richard Donald Prohaska, Castle Pines, CO (US); Arthur James Jur, Cleveland, TN (US); Abhishek Pratap Rao, Pune (IN)

(21) Appl. No.: 17/976,595

(22) Filed: Oct. 28, 2022

Related U.S. Application Data
(60) Provisional application No. 63/272,887, filed on Oct. 28, 2021.

(51) Int. Cl. H01H 85/20

(52) U.S. Cl. CPC H01H 85/2015; H01H 85/205; H01H 2085/2075

(57) ABSTRACT

An enclosure that houses one or more fuses includes one or more fuse positioning structures. A fuse housing in the enclosure holds the one or more fuses. Each fuse positioning structure includes one or more fuse seats. Each fuse seat is configured to contact and apply pressure to a respective fuse in the fuse housing. The fuse positioning structure(s) cause one or both terminals of each fuse to be seated in a respective fuse clip or clips.

### CROSS-REFERENCE TO RELATED APPLICATIONS

This application claims the benefit of U.S. Provisional Patent Application No. 63/272,887, filed Oct. 28, 2021. The disclosure of the priority application in its entirety is hereby incorporated by reference into the presence application.

### TECHNICAL FIELD

The present disclosure relates generally to fuse seats that enable the fuse terminals of fuses in an enclosure to be properly inserted into fuse clips.

### BACKGROUND

Fuses are used with a variety of electronic devices. A fuse is an electrical safety device that provides overcurrent protection to an electronic device. When a fault in the electronic device causes too much current to flow, a fuse breaks a circuit to interrupt the current flow. Typically, a fuse is held in a fuse housing that has fuse clips that secure and electrically connect to the terminals of the fuse. In some instances, at least one terminal of a fuse is partially inserted into a fuse clip, which can cause overheating at the terminal due to insufficient contact or insufficient contact pressure between the terminal and the fuse clip. Additionally, the fuse associated with the partially inserted terminal may not function as intended, which can result in the electronic device being damaged due to excessive current or heat.

### SUMMARY

An enclosure that houses a fuse or fuses includes one or more fuse positioning structures. A fuse housing in the enclosure holds one or more fuses. Each fuse positioning structure includes one or more fuse seats. Each fuse seat is configured to contact and apply pressure to a respective fuse in the fuse housing. The fuse positioning structure(s) cause one or both terminals of each respective fuse to be seated properly in a respective fuse clip or fuse clips. The terminal(s) is seated properly when there is sufficient contact and/or sufficient contact pressure between the terminal and a respective fuse clip.

In one aspect, an enclosure includes an access door, a fuse housing, and one or more fuse positioning structures. The fuse housing is configured to hold at least one fuse. The fuse housing includes fuse clips for each fuse. The fuse clips are operable to receive the terminals of the fuse. The one or more fuse positioning structures are attached to an interior surface of the access door. The fuse positioning structure(s) include one or more fuse seats, where each fuse seat is operable to contact a respective fuse in the fuse housing. When the one or more fuses are inserted into the fuse housing and the access door is closed, each fuse seat contacts a respective fuse and causes the terminals of the fuse to be seated in the fuse clips.

In another aspect, an enclosure includes a fuse housing and one or more movable fuse positioning structures. The fuse housing is configured to hold at least one fuse, and the fuse housing includes fuse clips for each fuse. The one or more movable fuse positioning structures are operably attached to an interior surface of the enclosure or to the fuse housing. Each movable fuse positioning structure is operable to engage or disengage the one or more fuses. Each movable fuse positioning structure includes at least one fuse seat that is configured to contact a respective fuse. When the one or more fuses are inserted into the fuse housing and the one or more movable fuse positioning structures contact the fuse(s), the at least one fuse seat contacts a respective fuse to cause the terminals of the fuse to be seated in the fuse clips of the respective fuse.

In yet another aspect, an enclosure includes a fuse housing and one or more attachable fuse positioning structures. The fuse housing is configured to hold at least one fuse, and the fuse housing includes fuse clips for each fuse. The one or more attachable fuse positioning structures are operable to attach to an interior surface of the enclosure or to the fuse housing and detach from the interior surface of the enclosure or the fuse housing. Each attachable fuse positioning structure includes at least one fuse seat that is configured to contact a respective fuse. When the one or more fuses are inserted into the fuse housing and the one or more attachable fuse positioning structures positioned on either the interior surface of the enclosure or the fuse housing engages the one or more fuses, the at least one fuse seat contacts a respective fuse to cause the terminals of the fuse to be seated in the fuse clips for that fuse.

In some instances, the one or more fuses, via the fuse clips of the fuse housing, are electrically connected to a monitoring device. The monitoring device monitors one or more characteristics of the fuse(s). For example, the monitoring device can monitor a temperature level, a voltage level, voltage presence, and/or fuse continuity. The monitoring device is operably connected to one or more output devices that present a value of a monitored characteristic and/or an indication of the monitored characteristic.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 illustrates a block diagram of example electrical system in accordance with the principles of the present disclosure;

FIG. 2 illustrates an example enclosure with an access door closed;

FIG. 3 illustrates the example enclosure shown in FIG. 2 with the access door opened;

FIG. 4 illustrates a first example enclosure that includes a fuse housing holding fuses and two fuse positioning structures on an access door in accordance with the principles of the present disclosure;

FIG. 5 illustrates an enlarged view showing the fuse positioning structures engaged with the fuses shown in FIG. 4 in accordance with the principles of the present disclosure;

FIG. 6 illustrates a second example enclosure that includes one fuse positioning structure in accordance with the principles of the present disclosure;

FIG. 7 illustrates an enlarged view showing the fuse positioning structure engaged with the fuses shown in FIG. 6 in accordance with the principles of the present disclosure;

FIG. 8 illustrates the fuse positioning structure of FIG. 4 in accordance with the principles of the present disclosure;

FIG. 9 illustrates the fuse positioning structure shown in FIG. 8 with conductive structures in accordance with the principles of the present disclosure;

FIG. 10 illustrates a third example enclosure that includes a fuse housing with fuses and a movable fuse positioning structure in accordance with the principles of the present disclosure, where the moveable fuse positioning structure is disengaged or not in contact with the fuses;

FIG. 11 illustrates the movable fuse positioning structure of FIG. 10 engaged or in contact with the fuses in accordance with the principles of the present disclosure;

FIG. 12 illustrates a fourth example enclosure that includes a fuse housing with fuses and an attachable fuse positioning structure in accordance with the principles of the present disclosure, where the attachable fuse positioning structure is not in contact with the fuses;

FIG. 13 illustrates the attachable fuse positioning structure of FIG. 12 in contact with the fuses in accordance with the principles of the present disclosure; and

FIG. 14 illustrates a block diagram of an example monitoring system in accordance with the principles of the present disclosure.

### DETAILED DESCRIPTION

Embodiments disclosed herein provide fuse positioning structures that enable the proper insertion of fuse terminals into fuse clips. One or more fuses are included in an enclosure. The enclosure can be any suitable type of enclosure that houses one or more fuses. In a non-limiting nonexclusive example, the enclosure houses a fusible disconnect switch, where the disconnect switch combines a switch to connect and disconnect a circuit or an electrical device to and from a power supply, and one or more fuses that provide overcurrent protection.

In one embodiment, one or more fuse positioning structures that each include one or more fuse seats are attached to an interior side of an access door of an enclosure. The fuse seat(s) contact the fuse or fuses when the access door is closed to ensure each fuse is seated in a fuse slot and the fuse terminals of the fuse are inserted into and seated in the fuse clips. The fuse seat(s) push any partially seated fuse terminal into the fuse clips.

In another embodiment, one or more fuse positioning structures that each include one or more fuse seats are attached to a movable (e.g., pivotable, rotatable) structure or structures, or are implemented as movable (e.g., pivotable, rotatable) fuse positioning structures. Each movable structure(s) or movable fuse positioning structure(s) is operably attached to an interior surface of an enclosure, such as the rear interior surface, or to a fuse housing (e.g., a switch base). When an access door of an enclosure is open, a user can move each movable structure (or movable fuse positioning structure) to an open or first position where each fuse seat does not contact a respective fuse and enables access to the fuse(s). Similarly, when the access door is open, the user may move each movable structure (or movable fuse positioning structure) to a closed or second position to enable each fuse seat to contact a respective fuse for proper insertion of the fuse terminals into the fuse clip(s).

In yet another embodiment, one or more fuse positioning structures that each include one or more fuse seats are attached to a panel that is configured to be attached to, and detached from, an interior surface of an enclosure or a surface of a fuse housing (e.g., the switch base) when the access door is open. For example, the panel can be attached and detached using any suitable type of fastener or fasteners, such as a screw, a screw and wing nut, a push latch, a magnetic catch, a flex-grip and roller catch, or other type of latch or catch. When a panel is attached to the enclosure or to the fuse housing, each fuse seat contacts a respective fuse to ensure the proper insertion of the fuse terminals into the fuse clip(s). When the access door is open and the panel is detached from the surface, each fuse seat does not contact the respective fuse and enables access to the fuse(s).

In some embodiments, a fuse positioning structure can include one or more conductive structures that enable one or more characteristics of a fuse, or of the operation of the disconnect switch, to be monitored. Each conductive structure contacts a respective fuse clip to provide an electrical contact with the fuse. The conductive structure is also electrically connected to a sensing or monitoring device that monitors the one or more characteristics, such as a temperature level, a voltage level, voltage presence, and/or fuse continuity. The monitoring device is operably connected to one or more output devices that present a value of a monitored characteristic and/or an indication of the monitored characteristic. For example, the monitoring device may be operably connected to a display that displays a level of the monitored characteristic (e.g., a voltage level). In some embodiments, the monitoring device is operably connected to one or more light indicators (e.g., light emitting diodes) that illuminate or do not illuminate to represent a monitored characteristic.

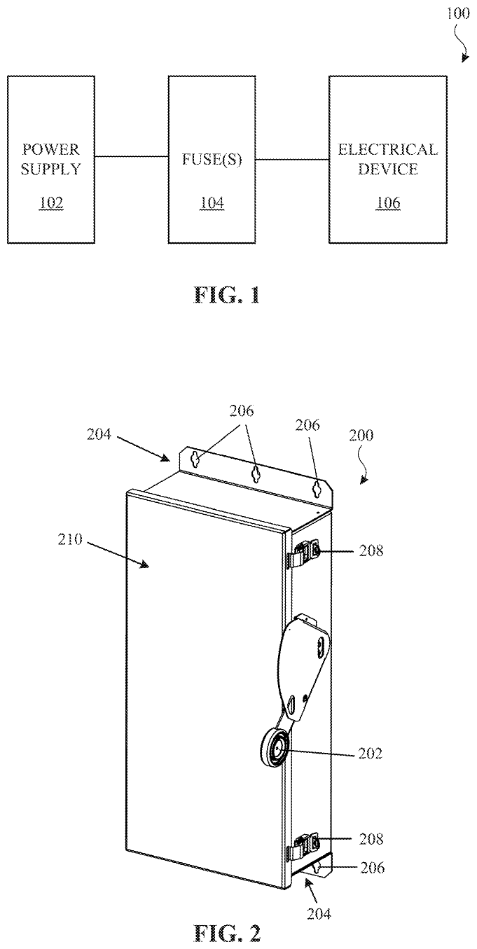

FIG. 1 illustrates a block diagram of example electrical system 100 in accordance with the principles of the present disclosure. The electrical system 100 includes a power supply 102 operably connected to one or more fuses 104. The power supply 102 can provide any suitable power, such as six hundred volts (600 V) alternating current (AC), two hundred and forty volts (240 V) AC or one hundred and twenty volts (120 V) AC.

The fuse(s) 104 are operably connected to an electrical device 106. Non-limiting nonexclusive examples of a fuse 104 is a Class H or a Class R replaceable one-time use fuse. In one example, when the electrical device 106 is in use, the one or more fuses protect the electrical device 106 from currents that exceed the ampere rating of the electrical device 106 (e.g., over currents).

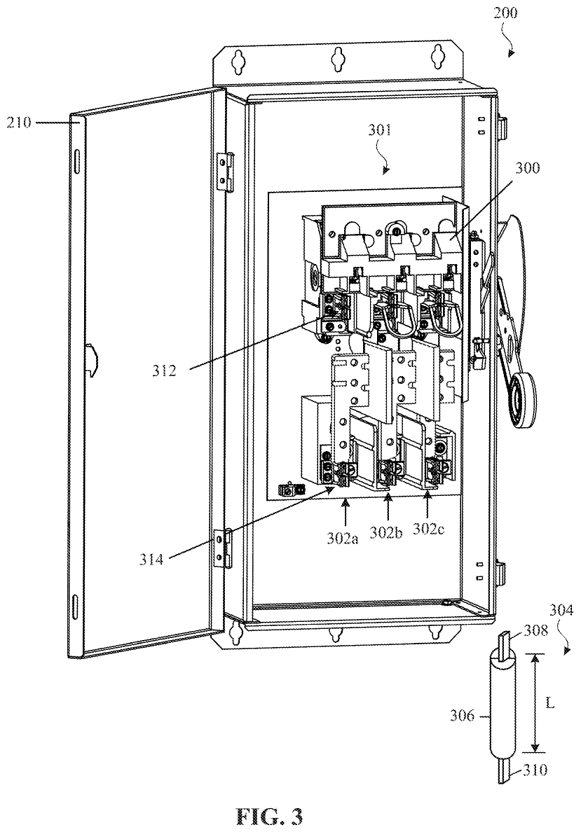

FIG. 2 illustrates an example enclosure 200 with an access door 210 in a closed position. The enclosure 200 can be made of any suitable material, such as metal. In the illustrated example, the enclosure 200 houses a disconnect switch (e.g., disconnect switch 301 in FIG. 3) that includes one or more fuses. A switch arm 202 positioned on the exterior of the enclosure 200 is operably connected to the disconnect switch to close and open the disconnect switch. The switch arm 202 can be positioned in a first position to turn off the disconnect switch (e.g., to open the disconnect switch), or in a second position to turn on the disconnect switch (e.g., to close the disconnect switch).

The enclosure 200 includes mounting flanges 204 that each define openings 206 for mounting the enclosure 200 on a wall or some other structure. The mounting flanges 204 can be positioned on one or more sides of the enclosure 200. In FIG. 2, the mounting flanges 204 are positioned on opposing top and bottom sides of the enclosure 200. In some embodiments, the enclosure 200 includes one or more interlock switches 208 that can prevent the opening of the access door 210. The disconnect switch and the one or more fuses are accessible when the access door 210 is opened.

FIG. 3 illustrates the enclosure 200 with the access door 210 in an open position. As discussed in conjunction with FIG. 2, the enclosure 200 houses a disconnect switch 301. The interior of the enclosure 200 includes a fuse housing 300 that includes one or more fuse slots. In the example, the fuse housing 300 includes three fuse slots 302a, 302b, 302c. A fuse 304 can be seated into each fuse slot 302a, 302b, 302c.

The example fuse 304 includes a fuse body 306, a first terminal 308, and a second terminal 310. The first terminal 308 is inserted into and held by a first fuse clip 312 in a respective fuse slot 302a, 302b, 302c. The second terminal 310 is inserted into and held by a second fuse clip 314 in the respective fuse slot 302a, 302b, 302c. The first fuse clips 312 are positioned at the top of the fuse slots 302a, 302b, 302c at an upper region of the fuse housing 300. The second fuse clips 314 are positioned at the bottom of the fuse slots 302a, 302b, 302c at a lower region of the fuse housing 300. In the illustrated example, the first and the second fuse clips 312, 314 are spring-loaded fuse clips, and the first and the second terminals 308, 310 are pushed into the first and the second fuse clips 312, 314, respectively, when the fuse body 306 is inserted into the fuse slot 302a, 302b, 302c. The first and the second fuse clips 312, 314 provide and maintain contact pressure on the first and the second terminals 308, 310 through the spring action.

The first and the second terminals 308, 310 electrically connect with the first and the second fuse clips 312, 314, respectively, when the fuses 304 are seated in the fuse slots 302a, 302b, 302c. The first and the second terminals 308, 310 can be inserted properly into the first and the second fuse clips 312, 314 prior to closing (e.g., turning on) the disconnect switch. However, in some instances, at least one terminal may be partially inserted into a fuse clip. The partial seating of a terminal can cause overheating at the terminal due to insufficient contact and/or insufficient contact pressure between the terminal and the fuse clip. Additionally or alternatively, the fuse associated with a partially inserted terminal may not function as intended. As will be described in more detail later, one or more fuse positioning structures can be included in an enclosure to seat the terminals properly into the fuse clips.

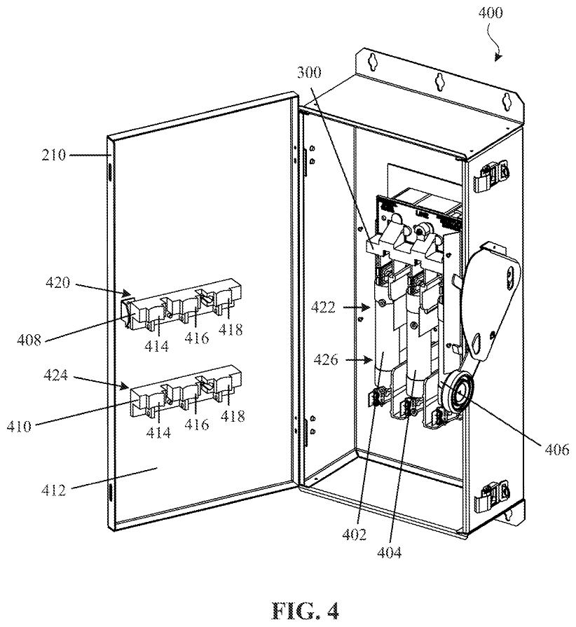

FIG. 4 illustrates a first example enclosure 400 that includes first and second fuse positioning structures 408, 410 in accordance with the principle of the present disclosure. The enclosure 400 includes the fuse housing 300 that is configured to hold fuses 402, 404, 406. In the illustrated example, the three fuses 402, 404, 406 each include first and second terminals 308, 310 that can be inserted into respective fuse slots 302a, 302b, 302c (see FIG. 3) in the fuse housing 300. The first fuse positioning structure 408 and the second fuse positioning structure 410 are attached to an interior surface 412 of the access door 210. The first and the second fuse positioning structures 408, 410 each include fuse seats 414, 416, 418. The fuse seats 414, 416, 418 are configured to contact and apply pressure to the fuses 402, 404, 406 when the access door 210 is closed.

Although two fuse positioning structures 408, 410 are shown in FIG. 4, other examples are not limited to this configuration. An enclosure can include one or more fuse positioning structures, and each fuse positioning structure may have one or more fuse seats. Additionally, each fuse positioning structure may be attached to the interior surface 412 of the access door 210 at any suitable location.

In the illustrated example, the first fuse positioning structure 408 is attached to the interior surface 412 of the access door 210 at a first location 420 that corresponds to a second location 422 of each fuse 402, 404, 406. The second fuse positioning structure 410 is attached to the interior surface 412 of the access door 210 at a third location 424 that corresponds to a fourth location 426 of the fuses 402, 404, 406. In FIG. 4, the second location 422 of the fuses 402, 404, 406 is an upper region of each fuse 402, 404, 406 near or adjacent the first fuse clips 312, and the fourth location 426 of the fuses 402, 404, 406 is a lower region of each fuse 402, 404, 406 near or adjacent the second fuse clips 314. When the access door 210 is closed, the fuse seats 414, 416, 418 of the first fuse positioning structure 408 contact the fuses 402, 404, 406 at the second location 422 and cause the first terminals 308 of the fuses 402, 404, 406 to be seated in the first fuse clips 312. Similarly, the fuse seats 414, 416, 418 of the second fuse positioning structure 410 contact the fuses 402, 404, 406 at the fourth location 426 and cause the second terminals 310 of the fuses 402, 404, 406 to be seated in the second fuse clips 314.

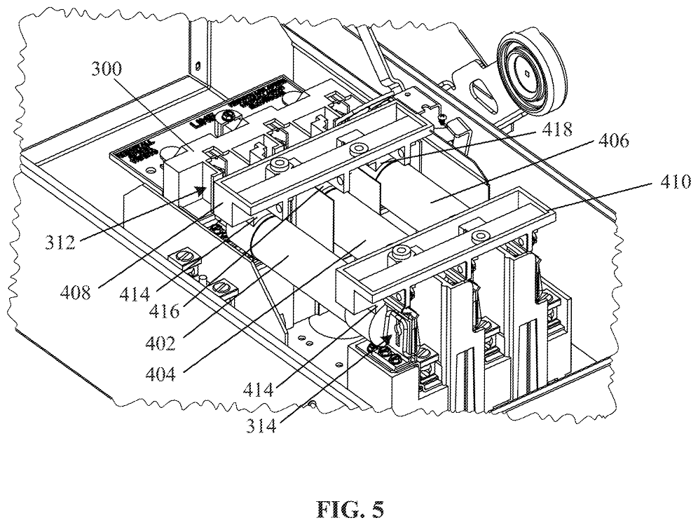

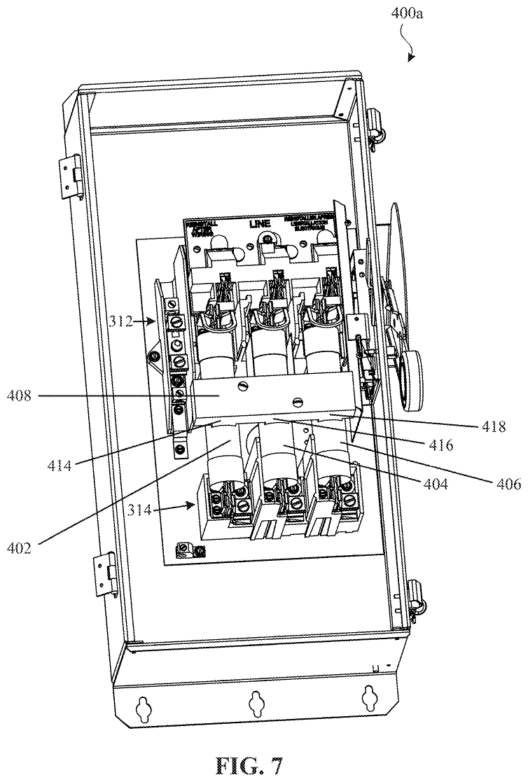

FIG. 5 illustrates an enlarged view of the fuse housing shown in FIG. 4. FIG. 5 shows the fuses 402, 404, 406 seated in the fuse slots 302a, 302b, 302c of the fuse housing 300 and the first and the second fuse positioning structures 408, 410 contacting the fuses 402, 404, 406. Although the access door 210 is closed in FIG. 7, the access door 210 is not shown to enable the fuse housing 300, the fuses 402, 404, 406, and the first and the second fuse positioning structures 408, 410 to be visible.

The fuse seats 414, 416, 418 of the first fuse positioning structure 408 contact the fuses 402, 404, 406 at the second location 422 of the fuses 402, 404, 406, and the fuse seats 414, 416, 418 of the second fuse positioning structure 410 contact the fuses 402, 404, 406 at the fourth location 426 of the fuses 402, 404, 406. The fuse seats 414, 416, 418 of the first and the second fuse positioning structures 408, 410 provide and maintain contact pressure on the fuses 402, 404, 406. The contact pressure applied by the fuse seats 414, 416, 418 of the first fuse positioning structure 408 causes the terminals (e.g., the first terminal 308) of the fuses 402, 404, 406 to be seated properly into respective first fuse clip 312. Similarly, the contact pressure applied by the fuse seats 414, 416, 418 of the second fuse positioning structure 410 causes the terminals (e.g., the second terminal 310) of the fuses 402, 404, 406 to be seated properly into respective second fuse clip 314. In one example, the size, the shape, and the dimensions of the first and the second fuse positioning structures 408, 410 can be based on the number of fuses, the distance between the access door and the fuse(s), the profile of the fuse(s), and/or the size of the fuse(s). Additionally or alternatively, the size and the shape of each fuse seat 414, 416, 418 can be based on the number of fuses, the size of the fuse that the fuse seat 414, 416, 418 will contact, the dimensions of the fuses, and the profile of the bodies of the fuses.

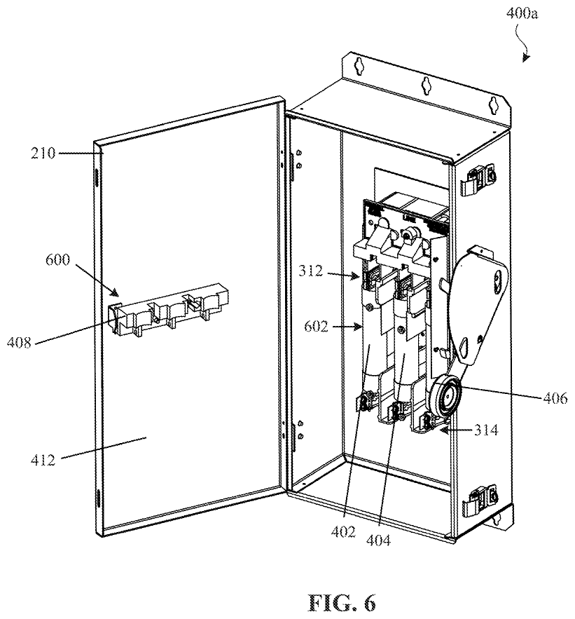

FIG. 6 illustrates a second example enclosure 400a that includes one fuse positioning structure in accordance with the principles of the present disclosure. A fuse positioning structure (e.g., first fuse positioning structure 408) is attached to the interior surface 412 of the access door 210 at a fifth location 600 that corresponds to a sixth location 602 of each fuse 402, 404, 406. When the access door 210 is closed, the fuse seats 414, 416, 418 of the first fuse positioning structure 408 contact the fuses 402, 404, 406 at the sixth location 602 of the fuses 402, 404, 406 to seat the first and the second terminals 308, 310 of the fuses 402, 404, 406 into respective first and second fuse clips 312, 314.

The sixth location 602 of the fuses 402, 404, 406 in the illustrated example is generally a middle region of each fuse 402, 404, 406. In one example, the middle region is substantially at a midpoint between the first fuse clip 312 and the second fuse clip 314 in a fuse slot (e.g., fuse slot 302a in FIG. 3). In another example, the middle region is substantially at a midpoint of the fuse body (e.g., a midpoint of a length L of the fuse body 306 in FIG. 3).

FIG. 7 illustrates an enlarged view of the fuse housing shown in FIG. 6. Although the access door 210 is not shown, it is deemed closed to show the fuse housing 300, the fuses 402, 404, 406, and the first fuse positioning structure 408. The fuses 402, 404, 406 are seated in respective fuse slots 302a, 302b, 302c of the fuse housing 300, and the first fuse positioning structure 408 contacts the fuses 402, 404, 406 at the sixth location of the fuses 402, 404, 406. When the access door 210 is closed, the contact pressure applied by the fuse seats 414, 416, 418 of the first fuse positioning structure 408 causes the terminals (e.g., the first and second terminal 308, 310) of the fuses 402, 404, 406 to be seated properly into respective first and second fuse clips 312, 314.

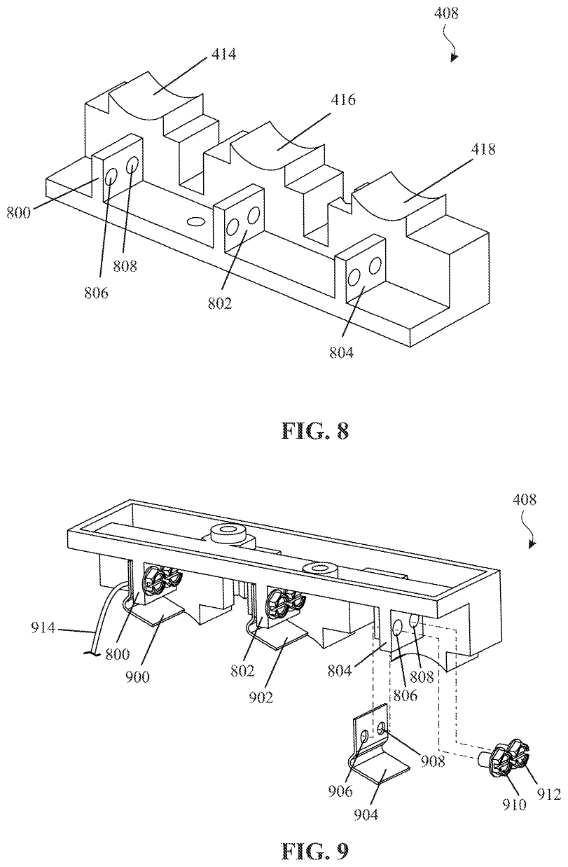

FIG. 8 illustrates a perspective view of the first fuse positioning structure 408 with attachment structures in accordance with the principles of the present disclosure. The first fuse positioning structure 408 is similar to the second fuse positioning structure 410. As such, only the first fuse positioning structure 408 will be described.

The example first fuse positioning structure 408 includes the fuse seats 414, 416, 418. The number of fuse seats 414, 416, 418 for the first fuse positioning structure 408 is based on the number of fuses the fuse seats 414, 416, 418 will contact or on the number of fuses to be seated in a fuse housing. In the example of FIGS. 3-7, the fuse housing 300 is configured to hold three fuses (e.g., fuses 402, 404, 406). Accordingly, the first fuse positioning structure 408 has the three fuse seats 414, 416, 418.

The size and the shape of each fuse seat 414, 416, 418 in the illustrated example are based on the size of the fuse that the fuse seat 414, 416, 418 will contact, the number of fuses, the dimensions of the fuses, and the profiles of the bodies of the fuses (e.g., fuse body 306). In the example shown in FIGS. 4-7, the fuses 402, 404, 406 have cylindrical fuse bodies, and the shape and the size of each fuse seat 414, 416, 418 is based on a profile (e.g., the curvature) of the section of the fuse that will contact the fuse seat 414, 416, 418. A fuse body can have a different shape and/or size in other examples. For example, a fuse body may have a rectangular shape, although alternatives are possible.

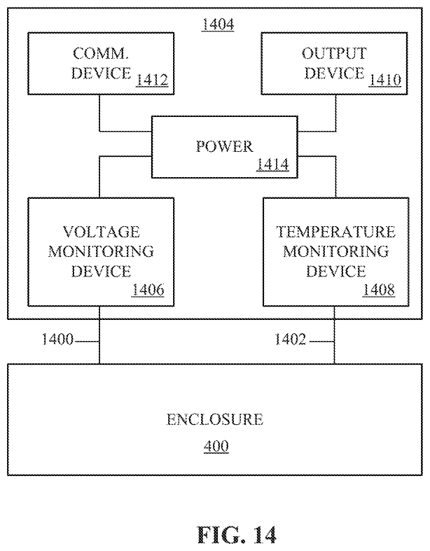

The attachment structures 800, 802, 804 may be positioned adjacent respective fuse seats 414, 416, 418. In the illustrated example, each attachment structure 800, 802, 804 includes openings 806, 808. Each attachment structure 800, 802, 804 is used to attach, via the openings 806, 808, conductive structures 900, 902, 904 (see FIG. 9) to the first fuse positioning structure 408. As will be described in more detail in conjunction with FIG. 9, the conductive structures 900, 902, 904 are configured to contact respective fuse clips 312, 314. For example, the conductive structures 900, 902, 904 are configured to contact fuse clips 312, 314 adjacent the attachment structure 800, 802, 804 to form an electrical connection between the conductive structures 900, 902, 904 and the fuse clips 312, 314. The electrical connection to the fuse clips creates an electrical connection between the respective conductive structures 900, 902, 904 and the first and second terminals 308, 310 inserted in the fuse clips 312, 314. The conductive structures 900, 902, 904 are also electrically connected to a monitoring device, such as an example monitoring device 1404 shown in FIG. 14. Thus, the conductive structures can be used to create an electrical connection between the fuse (via the terminals in the fuse clips) and the monitoring device, which enables one or more characteristics of the fuse to be monitored.

FIG. 9 illustrates the first fuse positioning structure 408 with the conductive structures 900, 902 attached to the attachment structures 800, 802, respectively, via fasteners 910, 912. A conductive structure 904 is shown detached from the attachment structure 804. As described above, the conductive structures 900, 902, 904 are operable to contact the first and second fuse clips 312, 314 when the first fuse positioning structure 408 contacts the fuses 402, 404, 406 (e.g., when the access door 210 (FIG. 2) is closed). One or more dimensions of the conductive structures 900, 902, 904 (e.g., the height) is determined so the conductive structures 900, 902, 904 push or bend against the first and second fuse clips 312, 314. The bending of the conductive structures 900, 902, 904 against the first and second fuse clips 312, 314 produces a desirable or proper contact between the first and second fuse clips 312, 314 and the conductive structures 900, 902, 904 when the first fuse positioning structure 408 is in contact with the fuses 402, 404, 406. In the example shown in FIGS. 4-7, the conductive structures 900, 902, 904 push or bend against the first and second fuse clips 312, 314 when the access door 210 is closed.

The conductive structures 900, 902, 904 define openings 906, 908 for receiving the fasteners 910, 912 to provide an attachment mechanism. To attach a conductive structure 900, 902, 904 to a respective attachment structure 800, 802, 804, the conductive structure 900, 902, 904 is positioned adjacent the respective attachment structure 800, 802, 804 such that the openings 906, 908 align with the openings 806, 808 of the attachment structures 800, 802, 804. The fastener 910 is inserted through the aligned openings 806, 906, and the fastener 912 is inserted through the aligned openings 808, 908 to attach each conductive structure 900, 902, 904 to the respective attachment structure 800, 802, 804. In the illustrated embodiment, the openings 806, 808, 906, 908 are threaded openings and the fasteners 910, 912 are screws, although other embodiments are not limited to this type of attachment mechanism.

A conductive line can be operably connected to a respective conductive structure 900, 902, 904. Only one conductive line 914 is shown in FIG. 9. In a non-limiting example, the conductive lines can be soldered to the conductive structures 900, 902, 904. The conductive lines can also be operably connected to the monitoring device 1404 (see FIG. 14) to electrically connect the conductive structures 900, 902, 904 to the monitoring device 1404. Fuses in a fuse housing can be electrically and operably connected to the monitoring device 1404 via fuse clips and associated conductive structures.

Other examples are not limited to the construction of the conductive structures 900, 902, 904, and/or to the attachment mechanism used to attach the conductive structures 900, 902, 904 to the fuse positioning structure 408. Any suitably configured conductive structure can be used to electrically connect a fuse terminal, via a fuse clip, to a monitoring device. Additionally, conductive structures can be attached to a fuse positioning structure using any suitable attachment mechanism. For example, a conductive structure can be positioned to contact a fuse clip and may be attached to a fuse positioning structure with an adhesive.

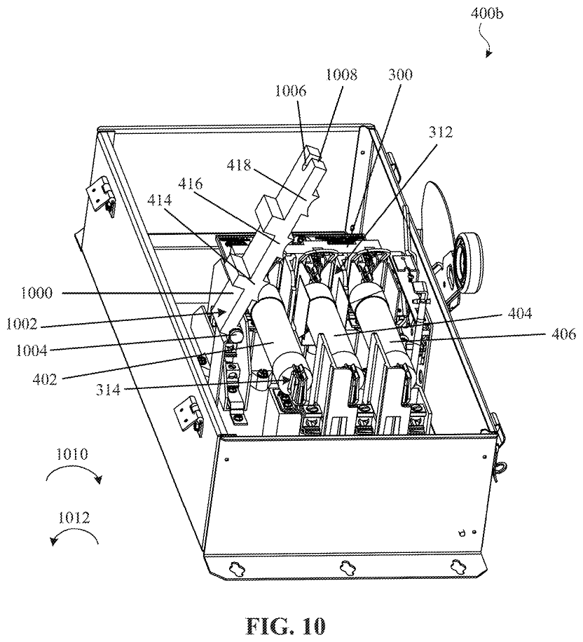

FIG. 10 illustrates a third example enclosure 400b that includes a movable fuse positioning structure 1000 in accordance with the principles of the present disclosure, where the movable fuse positioning structure 1000 is not in contact with the fuses 402, 404, 406. For simplicity, the access door 210 of the enclosure 400b is not shown in FIG. 10.

The enclosure 400b includes the fuse housing 300 with fuses 402, 404, 406 inserted into the fuse slots 302a, 302b, 302c of the fuse housing 300, and the movable fuse positioning structure 1000. In the illustrated example, a first end 1002 of the movable fuse positioning structure 1000 is attached to the fuse housing 300 by a hinged attachment structure 1004 (e.g., a pin member). The movable fuse positioning structure 1000 is similar to the first fuse positioning structure 408 shown in FIG. 8 except for the cutout 1006 at a second end 1008 of the movable fuse positioning structure 1000.

The hinged attachment structure 1004 enables the movable fuse positioning structure 1000 to rotate onto and away from the fuses 402, 404, 406. In the illustrated embodiment, when the movable fuse positioning structure 1000 is rotated in a first direction 1010 to cause the movable fuse positioning structure 1000 to contact the fuses 402, 404, 406, the fuse seats 414, 416, 418 of the movable fuse positioning structure 1000 contact the fuses 402, 404, 406 at the sixth location 602. The fuse seats 414, 416, 418 apply pressure to the fuses 402, 404, 406 to seat the first and second terminals 308, 310 of the fuses 402, 404, 406 into respective first and second fuse clips 312, 314. The fuse seats 414, 416, 418 do not contact the fuses 402, 404, 406 when the movable fuse positioning structure 1000 is rotated in a second direction 1012 away from the fuses 402, 404, 406.

Although FIG. 10 depicts one movable fuse positioning structure 1000, other examples are not limited to this implementation. For example, an enclosure can include one or more movable fuse positioning structures that are each positioned at any suitable location with respect to the fuses 402, 404, 406. For example, the enclosure 400b may include two movable fuse positioning structures 1000 that contact the fuses 402, 404, 406 at locations similar to the second and the fourth locations 422, 426 shown in FIG. 4. Additionally, the movable fuse positioning structure 1000 can be operably attached to a switch housing or to an interior surface of the enclosure using a different type of attachment structure. Any suitable attachment structure that is operable to move the movable fuse positioning structure(s) with respect to the fuses 402, 404, 406 can be used. For example, a movable fuse positioning structure may be movable with respect to the fuses 402, 404, 406 via a sliding attachment structure.

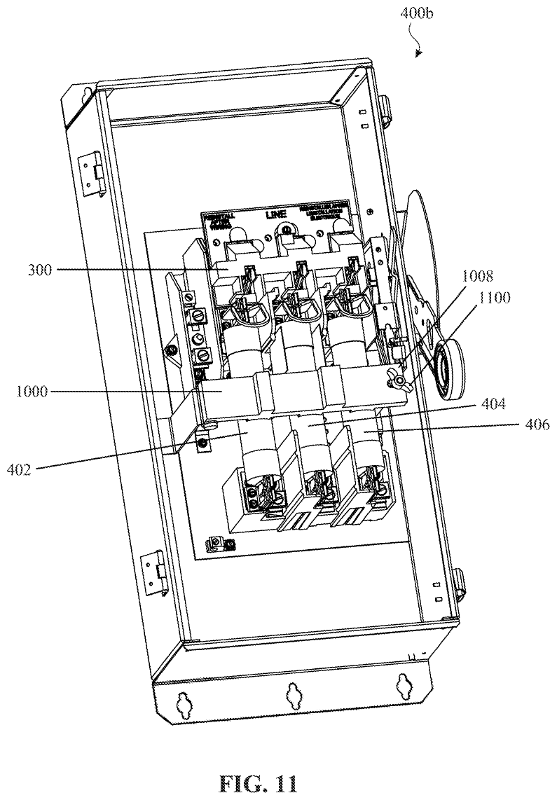

FIG. 11 illustrates the third example enclosure shown in FIG. 10 with the movable fuse positioning structure 1000 in contact with the fuses 402, 404, 406 in accordance with the principles of the present disclosure. For simplicity, the access door 210 of the enclosure 400b is not shown in FIG. 11.

The fuses 402, 404, 406 are seated in respective fuse slots 302a, 302b, 302c of the fuse housing 300, and the movable fuse positioning structure 1000 has been rotated in the first direction 1010 to contact the fuses 402, 404, 406 at the sixth location 602 of the fuses 402, 404, 406. In the illustrated example, the movable fuse positioning structure 1000 is secured to the fuse housing 300 at the second end 1008 of the movable fuse positioning structure 1000 with a fastener 1100 (e.g., a wing nut). For example, a screw on the fuse housing 300 can extend through the cutout 1006 (FIG. 10) and be used to secure the movable fuse positioning structure 1000 to the fuse housing 300 via the fastener 1100. Other examples can use a different type of fastener, such as a screw that is inserted through the cutout 1006 and inserted into a threaded insert in the fuse housing 300.

In other examples, the movable fuse positioning structure 1000 can be held against the fuses 402, 404, 406 using any suitable mechanism. For example, in another example, a movable fuse positioning structure can have a given height that is determined based on a distance between an interior surface of an access door of the enclosure 400b and the fuses 402, 404, 406. When the access door is closed, the interior surface of the access door can press against the movable fuse positioning structure 1000 to cause the first and the second terminals 308, 310 of the fuses 402, 404, 406 to be seated into respective first and second fuse clips 312, 314. Thus, the movable fuse positioning structure can be pressed against the fuses 402, 404, 406 without the use of a fastener.

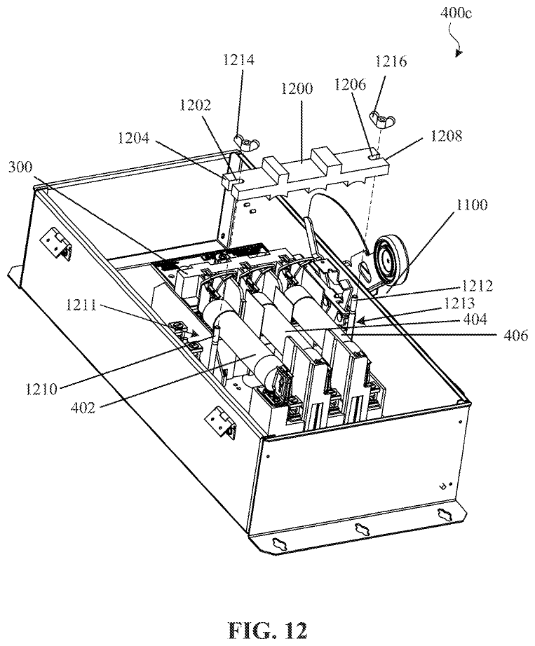

FIG. 12 illustrates a fourth example enclosure 400c that includes an attachable fuse positioning structure 1200 in accordance with the principles of the present disclosure, where the attachable fuse positioning structure 1200 is not in contact with the fuses 402, 404, 406. For simplicity, an access door of the enclosure 400c is not shown in FIG. 12.

The enclosure 400c also includes the fuse housing 300, fuses 402, 404, 406 inserted into the fuse slots 302a, 302b, 302c of the fuse housing 300. A first cutout 1202 is formed in a first end 1204 of the attachable fuse positioning structure 1200, and a second cutout 1206 is formed in a second end 1208 of the attachable fuse positioning structure 1200. The attachable fuse positioning structure 1200 is similar to the first fuse positioning structure 408 shown in FIG. 8 except for the first and the second cutouts 1202, 1206.

A first post 1210 is attached to the fuse housing 300 at a first location 1211 that corresponds to the first cutout 1202. A second post 1212 is attached to the fuse housing 300 at a second location 1213 opposite the first location 1211 that corresponds to the second cutout 1206. The first and the second posts 1210, 1212 are configured to extend through the first and the second cutouts 1202, 1206, respectively, when the attachable fuse positioning structure 1200 contacts the fuses 402, 404, 406. A first fastener 1214 is configured to attach to the first post 1210 and a second fastener 1216 is configured to attach to the second post 1212 to secure the attachable fuse positioning structure 1200 to the fuse housing 300. When the attachable fuse positioning structure 1200 is secured to the fuse housing 300, the fuse seats 414, 416, 418 contact and apply pressure to the fuses 402, 404, 406 to seat the first and the second terminals 308, 310 of the fuses 402, 404, 406 into respective first and second fuse clips 312, 314.

When the attachable fuse positioning structure 1200 is to be detached from the fuse housing 300, the first and the second fasteners 1214, 1216 are detached from the first and the second posts 1210, 1212. Once the first and the second fasteners 1214, 1216 are detached, the attachable fuse positioning structure 1200 can be lifted off the fuses 402, 404, 406 to enable a user to access the fuses 402, 404, 406.

In the illustrated example, the first and the second posts 1210, 1212 are threaded posts and the first and the second fasteners 1214, 1216 are wing nuts. In other example, the attachable fuse positioning structure 1200 can contact and be secured against the fuses 402, 404, 406 using any suitable attachment mechanism. For example, the first and the second fasteners 1214, 1216 may be screws that are inserted into the first and the second cutouts 1202, 1206, respectively, and received by a threaded insert in the fuse housing 300.

Although FIG. 12 depicts one attachable fuse positioning structure 1200, other examples are not limited to this implementation. The enclosure 400c can include one or more attachable fuse positioning structures that are each positioned at any suitable location with respect to the fuses 402, 404, 406. For example, the enclosure 400c may include two attachable fuse positioning structures 1200 that contact the fuses 402, 404, 406 at locations similar to the second and the fourth locations 422, 426 shown in FIG. 4. Additionally, the attachable fuse positioning structure 1200 can be operably attached to an interior surface of the enclosure 400c in addition to, or instead of, a fuse housing.

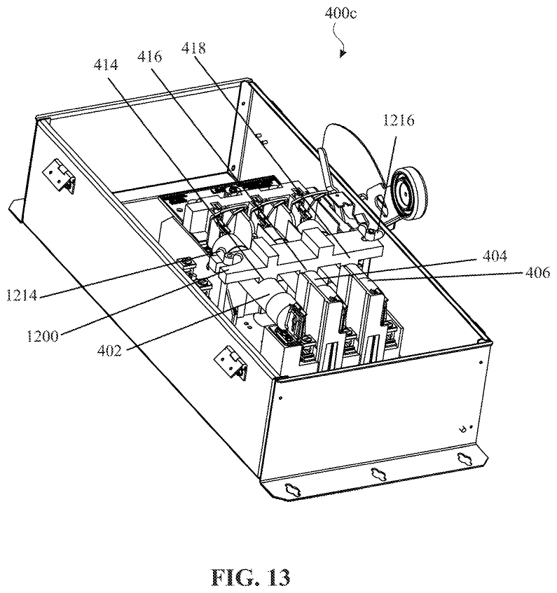

FIG. 13 illustrates the fourth example enclosure 400c shown in FIG. 12 with the attachable fuse positioning structure 1200 in contact with the fuses 402, 404, 406 in accordance with the principles of the present disclosure. For simplicity, the access door of the enclosure 400c is not shown in FIG. 13.

The fuses 402, 404, 406 are shown seated in respective fuse slots 302a, 302b, 302c of the fuse housing 300, and the fuse seats 414, 416, 418 of the attachable fuse positioning structure 1200 contact the fuses 402, 404, 406 at the sixth location 602 of the fuses 402, 404, 406. In the illustrated example, the attachable fuse positioning structure 1200 is secured to the fuse housing 300 via the attachment of the first and the second fasteners 1214, 1216 to the first and the second posts 1210, 1212, respectively.

The movable fuse positioning structure 1000 shown in FIG. 10 and/or the attachable fuse positioning structure 1200 depicted in FIG. 12 can include one or more conductive structures that are used to electrically connect one or more fuse clips to a monitoring device. For example, the conductive structures can be similar to the conductive structures 900, 902, 904 shown in FIG. 9.

FIG. 14 illustrates a block diagram of the example monitoring device 1404 in accordance with the principles of the present disclosure. The conductive lines 1400, 1402 that are operably attached to conductive structures in the enclosure 400 provide data signals to the monitoring device 1404. The conductive lines 1400, 1402 each represent one or more conductive lines. In one embodiment, the conductive line 1400 is the conductive line 914 shown in FIG. 9 and the conductive line 1402 is a separate conductive line that is attached to the same conductive structure (e.g., conductive structure 902) or to another conductive structure (e.g., conductive structure 904 in FIG. 9). In another embodiment, the conductive lines 1400, 1402 are different conductive lines that are operably connected to the conductive lines (e.g., conductive line 914) attached to the conductive structures in the enclosure 400 (e.g., conductive structures 902, 904, 906 in FIG. 9).

The data signals received from the conductive structures in the enclosure 400 (e.g., conductive structures 900, 902, 904 in FIG. 9) can be input into a voltage monitoring device 1406 via the conductive line 1400. In a non-limiting example, the voltage monitoring device 1406 is implemented as one or more voltage measurement circuits, a digital or analog multimeter, or a voltmeter. The voltage monitoring device 1406 can be used, for example, to detect the presence of a voltage at a fuse clip and/or to measure a voltage level at the fuse clip.

In some examples, the monitoring device 1404 includes a temperature monitoring device 1408 in addition to, or as an alternative to, the voltage monitoring device 1406. The data signals received from the conductive structures in the enclosure 400 (e.g., conductive structures 900, 902, 904 in FIG. 9) can be input into the temperatures monitoring device 1408 via the conductive line 1402. The temperature monitoring device 1408 senses the temperature at a fuse clip. In a non-limiting example, the temperature monitoring device 1408 is implemented as one or more thermistors, one or more temperature sensors, or a digital or analog multimeter.

The example monitoring device 1404 can include one or more output devices (collectively referred to as output device 1410). Example output devices include, but are not limited to, a display, one or more light indicators (e.g., light emitting diodes), and/or one or more speakers. The output device 1410 is used to provide a value of a monitored characteristic and/or an indication of the monitored characteristic or characteristics (e.g., voltage level, voltage presence, and/or temperature level). The output device 1410 enables the monitored characteristic(s) to be determined and monitored by a person regardless of whether the access door of the enclosure (e.g., access door 210 in FIG. 2) is opened or closed.

In some examples, the monitored characteristic(s) is monitored remotely. One or more communication devices (represented by communication device 1412) can be included in the monitoring device 1404. The communication device 1412 may be a wired or a wireless communication device. Example communication devices include, but are not limited to, a near field probe, a short-range wireless device (e.g., BLUETOOTH), a mobile communication device (e.g., cellular), a Wi-Fi device, or combinations thereof.

A power supply 1414 is operably connected to the voltage monitoring device 1406 and/or the temperature monitoring device 1408. The power supply 1414 may also be operably connected to the output device 1410 and the communication device 1412. Any suitable power supply can be used, such as a battery (or batteries), a wired power adaptor that plugs into an electrical outlet (e.g., a wall outlet), or another electrical device that is operably connected to the monitoring device 1404 (e.g., a USB connector between the monitoring device and a computing device).

As discussed earlier, some or all of the components in the monitoring device 1404 can be included in an enclosure (e.g., enclosure 400) or positioned remotely from an enclosure. For example, the power supply 1414, the voltage monitoring device 1406 and/or the temperature monitoring device 1408, and the communication device 1412 are included in an enclosure while the output device 1410 is positioned remote from the enclosure.

Alternatively, the voltage monitoring device 1406, the temperature monitoring device 1408, the output device 1410, the communication device 1412, and the power supply 1414 may be positioned outside of the enclosure (e.g., on a remote panel). In such examples, the conductive lines 1400, 1402 can connect to one or more conductive contacts or voltage taps within the enclosure (e.g., where other signal lines or cables enter the enclosure) and separate conductive lines can connect the conductive contacts to the monitoring device 1404.

### Aspects of the Disclosure

Aspect 1. An enclosure, comprising:

a fuse housing configured to hold a fuse, the fuse housing comprising fuse clips operable to receive terminals of the fuse;

an access door; and

a fuse positioning structure attached to an interior surface of the access door, the fuse positioning structure having a fuse seat that is operable to contact the fuse to cause the terminals of the fuse to be seated in the fuse clips when the fuse is inserted into the fuse housing and the access door is closed.

Aspect 2. The enclosure of aspect 1, wherein one or more dimensions of the fuse seat are based on a size and a shape of a body of the fuse.
Aspect 3. The enclosure of claim 1, wherein:

the fuse seat is a first fuse seat;

the fuse is a first fuse;

the fuse positioning structure includes the first fuse seat and a second fuse seat; and

one or more dimensions of the fuse positioning structure are based on a size and a shape of the first fuse and a size and a shape of a second fuse.

Aspect 4. The enclosure of aspect 1, wherein the fuse positioning structure includes conductive structures that are attached to the fuse positioning structure and configured to contact a respective fuse clip.
Aspect 5. The enclosure of aspect 4, wherein the conductive structure is operably connected to a monitoring device.
Aspect 6. The enclosure of aspect 5, wherein the monitoring device comprises a voltage monitoring device.
Aspect 7. The enclosure of aspect 5, wherein the monitoring device comprises a temperature monitoring device.
Aspect 8. The enclosure of aspect 5, wherein the monitoring device comprises an output device.
Aspect 9. The enclosure of aspect 5, wherein the monitoring device comprises a communication device.
Aspect 10. The enclosure of aspect 1, wherein:

the fuse seat is a first fuse seat;

the fuse positioning structure is a first fuse positioning structure that is attached to the interior surface of the access door at a first location that causes the first fuse seat to contact an upper region of the fuse when the access door is closed;

the enclosure further comprises a second fuse positioning structure having a second fuse seat, the second fuse positioning structure attached to the interior surface of the access door at a second location that causes the second fuse seat to contact a lower region of the fuse when the access door is closed;

the fuse clips comprise a first fuse clip positioned at a top of a fuse slot of the fuse housing and a second fuse clip positioned at a bottom of the fuse slot;

the terminals of the fuse comprise a first terminal and a second terminal; and

when the access door is closed, the first fuse positioning structure is operable to cause the first terminal to be seated in the first fuse clip and the second fuse positioning structure is operable to cause the second terminal to be seated in the second fuse clip.

Aspect 11. The enclosure of aspect 1, wherein:

the fuse positioning structure is attached to the access door at a location that causes the fuse seat to contact a middle region of the fuse when the access door is closed;

the fuse clips comprise a first fuse clip positioned at a top of a fuse slot in the fuse housing and a second fuse clip positioned at a bottom of the fuse slot;

the terminals of the fuse comprise a first terminal and a second terminal; and

when the access door is closed, the fuse positioning structure is operable to cause the first terminal to be seated in the first fuse clip and the second terminal to be seated in the second fuse clip.

Aspect 12. An enclosure, comprising:

a fuse housing configured to hold a fuse, the fuse housing comprising fuse clips operable to receive terminals of the fuse; and

a movable fuse positioning structure attached to an interior surface of the enclosure or to the fuse housing and configured to move onto and away from the fuse, the movable fuse positioning structure having a fuse seat operable to contact the fuse to cause the terminals of the fuse to be seated in the fuse clips when the fuse is inserted into the fuse housing and the movable fuse positioning structure contacts the fuse.

Aspect 13. The enclosure of aspect 12, wherein one or more dimensions of the fuse seat are based on a size and a shape of a body of the fuse.
Aspect 14. The enclosure of aspect 12, wherein:

the fuse is a first fuse;

the fuse seat is a first fuse seat;

the movable fuse positioning structure includes the first fuse seat and a second fuse seat; and

one or more dimensions of the movable fuse positioning structure are based on a size and a shape of the first fuse and a size and a shape of a second fuse.

Aspect 15. The enclosure of aspect 12, wherein the movable fuse positioning structure includes conductive structures that are attached to the movable fuse positioning structure and configured to contact a respective fuse clip.
Aspect 16. The enclosure of aspect 15, wherein the conductive structure is operably connected to a monitoring device.
Aspect 17. The enclosure of aspect 16, wherein the monitoring device comprises a voltage monitoring device.
Aspect 18. The enclosure of aspect 16, wherein the monitoring device comprises a temperature monitoring device.
Aspect 19. The enclosure of aspect 16, wherein the monitoring device comprises an output device.
Aspect 20. The enclosure of aspect 16, wherein the monitoring device comprises a communication device.
Aspect 21. The enclosure of aspect 12, wherein:

the fuse seat is a first fuse seat;

the movable fuse positioning structure is a first movable fuse positioning structure that is configured to contact an upper region of the fuse when the first movable fuse positioning structure is in contact with the fuse;

the enclosure further comprises a second movable fuse positioning structure having a second fuse seat, the second movable fuse positioning structure attached to the interior surface of the enclosure or the fuse housing at a second location that causes the second fuse seat to contact a lower region of the fuse when the second movable fuse positioning structure is in contact with the fuse;

the fuse clips comprise a first fuse clip positioned at a top of a fuse slot of the fuse housing and a second fuse clip positioned at a bottom of the fuse slot;

the terminals of the fuse comprise a first terminal and a second terminal; and

when the first and the second fuse seats are in contact with the fuse, the first movable fuse positioning structure is operable to cause the first terminal to be seated in the first fuse clip and the second movable fuse positioning structure is operable to cause the second terminal to be seated in the second fuse clip.

Aspect 22. The enclosure of aspect 12, wherein:

the movable fuse positioning structure is configured to contact a middle region of the fuse when the movable fuse positioning structure is in contact with the fuse;

the fuse clips comprise a first fuse clip positioned at a top of a fuse slot in the fuse housing and a second fuse clip positioned at a bottom of the fuse slot;

the terminals of the fuse comprise a first terminal and a second terminal; and

when the fuse seat of the movable fuse positioning structure is in contact with the fuse, the movable fuse positioning structure is operable to cause the first terminal to be seated in the first fuse clip and the second terminal to be seated in the second fuse clip.

Aspect 23. An enclosure, comprising:

a fuse housing configured to hold a fuse, the fuse housing comprising fuse clips operable to receive terminals of the fuse; and

an attachable fuse positioning structure configured to be attached to an interior surface of the enclosure or to the fuse housing, the attachable fuse positioning structure having a fuse seat that is operable to contact the fuse to cause the terminals of the fuse to be seated in the fuse clips when the fuse is inserted into the fuse housing and the attachable fuse positioning structure is attached to the interior surface of the enclosure or to the fuse housing.

Aspect 24. The enclosure of aspect 23, wherein one or more dimensions of the fuse seat are based on a size and a shape of a body of the fuse.
Aspect 25. The enclosure of aspect 23, wherein:

the fuse seat is a first fuse seat;

the fuse is a first fuse;

the attachable fuse positioning structure includes the first fuse seat and a second fuse seat; and

one or more dimensions of the attachable fuse positioning structure are based on a size and a shape of the first fuse and a size and a shape of a second fuse.

Aspect 26. The enclosure of aspect 23, wherein the attachable fuse positioning structure includes conductive structures that are attached to the attachable fuse positioning structure and configured to contact a respective fuse clip.
Aspect 27. The enclosure of aspect 26, wherein the conductive structure is operably connected to a monitoring device.
Aspect 28. The enclosure of aspect 27, wherein the monitoring device comprises a voltage monitoring device.
Aspect 29. The enclosure of aspect 27, wherein the monitoring device comprises a temperature monitoring device.
Aspect 30. The enclosure of aspect 27, wherein the monitoring device comprises an output device.
Aspect 31. The enclosure of aspect 27, wherein the monitoring device comprises a communication device.
Aspect 32. The enclosure of aspect 23, wherein:

the fuse seat is a first fuse seat;

the attachable fuse positioning structure is a first attachable fuse positioning structure that is attachable to the interior surface of the enclosure or to the fuse housing at a first location that causes the first fuse seat to contact an upper region of the fuse when the attachable fuse positioning structure is attached to the interior surface of the enclosure or to the fuse housing;

the enclosure further comprises a second attachable fuse positioning structure having a second fuse seat, the second attachable fuse positioning structure attachable to the interior surface of the enclosure or to the fuse housing at a second location that causes the second fuse seat to contact a lower region of the fuse when the attachable fuse positioning structure is attached to the interior surface of the enclosure or to the fuse housing;

the fuse clips comprise a first fuse clip positioned at a top of a fuse slot of the fuse housing and a second fuse clip positioned at a bottom of the fuse slot;

the terminals of the fuse comprise a first terminal and a second terminal; and

when the first and the second attachable fuse positioning structures are attached to the interior surface of the enclosure or to the fuse housing, the first attachable fuse positioning structure is operable to cause the first terminal to be seated in the first fuse clip and the second attachable fuse positioning structure is operable to cause the second terminal to be seated in the second fuse clip.

Aspect 33. The enclosure of aspect 23, wherein:

the attachable fuse positioning structure is attachable to the interior surface of the enclosure or to the fuse housing at a location that causes the fuse seat to contact a middle region of the fuse when the attachable fuse positioning structure is attached to the interior surface of the enclosure or to the fuse housing;

the fuse clips comprise a first fuse clip positioned at a top of a fuse slot in the fuse housing and a second fuse clip positioned at a bottom of the fuse slot;

the terminals of the fuse comprise a first terminal and a second terminal; and

when the attachable fuse positioning structure is attached to the interior surface of the enclosure or to the fuse housing, the attachable fuse positioning structure is operable to cause the first terminal to be seated in the first fuse clip and the second terminal to be seated in the second fuse clip.

Aspect 34. A system, comprising:

an enclosure, comprising:
a fuse housing configured to hold a fuse, the fuse housing comprising fuse clips operable to receive terminals of the fuse;
an access door; and
a fuse positioning structure attached to an interior surface of the access door, the fuse positioning structure having a fuse seat that is operable to contact the fuse to cause the terminals of the fuse to be seated in the fuse clips when the fuse is inserted into the fuse housing and the access door is closed; and

a monitoring device operably connected to at least one fuse clip.

Aspect 35. A system, comprising:

an enclosure, comprising:
a fuse housing configured to hold a fuse, the fuse housing comprising fuse clips operable to receive terminals of the fuse; and
a movable fuse positioning structure attached to an interior surface of the enclosure or to the fuse housing and configured to move onto and away from the fuse, the movable fuse positioning structure having a fuse seat operable to contact the fuse to cause the terminals of the fuse to be seated in the fuse clips when the fuse is inserted into the fuse housing and the movable fuse positioning structure contacts the fuse; and

a monitoring device operably connected to at least one fuse clip.

Aspect 36. A system, comprising:

an enclosure, comprising:
a fuse housing configured to hold a fuse, the fuse housing comprising fuse clips operable to receive terminals of the fuse;
an attachable fuse positioning structure configured to be attached to an interior surface of the enclosure or to the fuse housing, the attachable fuse positioning structure having a fuse seat that is operable to contact the fuse to cause the terminals of the fuse to be seated in the fuse clips when the fuse is inserted into the fuse housing and the attachable fuse positioning structure is attached to the interior surface of the enclosure or to the fuse housing; and

a monitoring device operably connected to at least one fuse clip.

Various modifications and alterations of this disclosure will become apparent to those skilled in the art without departing from the scope and spirit of this disclosure, and it should be understood that the inventive scope of this disclosure is not to be unduly limited to the illustrative embodiments set forth herein.

What is claimed is:

1. An enclosure, comprising:
a fuse housing configured to hold a fuse, the fuse housing comprising fuse clips operable to receive terminals of the fuse;
an access door; and
a fuse positioning structure attached to an interior surface of the access door, the fuse positioning structure having a fuse seat that is operable to contact the fuse to cause the terminals of the fuse to be seated in the fuse clips when the fuse is inserted into the fuse housing and the access door is closed.

2. The enclosure of claim 1, wherein one or more dimensions of the fuse seat are based on a size and a shape of a body of the fuse.

3. The enclosure of claim 1, wherein:
the fuse seat is a first fuse seat;
the fuse is a first fuse;
the fuse positioning structure includes the first fuse seat and a second fuse seat; and
one or more dimensions of the fuse positioning structure are based on a size and a shape of the first fuse and a size and a shape of a second fuse.

4. The enclosure of claim 1, wherein the fuse positioning structure includes conductive structures that are attached to the fuse positioning structure and configured to contact a respective fuse clip.

5. The enclosure of claim 4, wherein the conductive structure is operably connected to a monitoring device.

6. The enclosure of claim 5, wherein the monitoring device comprises a voltage monitoring device or a temperature monitoring device.

7. The enclosure of claim 5, wherein the monitoring device comprises an output device.

8. The enclosure of claim 5, wherein the monitoring device comprises a communication device.

9. The enclosure of claim 1, wherein:
the fuse seat is a first fuse seat;
the fuse positioning structure is a first fuse positioning structure that is attached to the interior surface of the access door at a first location that causes the first fuse seat to contact an upper region of the fuse when the access door is closed;
the enclosure further comprises a second fuse positioning structure having a second fuse seat, the second fuse positioning structure attached to the interior surface of the access door at a second location that causes the second fuse seat to contact a lower region of the fuse when the access door is closed;
the fuse clips comprise a first fuse clip positioned at a top of a fuse slot of the fuse housing and a second fuse clip positioned at a bottom of the fuse slot;
the terminals of the fuse comprise a first terminal and a second terminal; and
when the access door is closed, the first fuse positioning structure is operable to cause the first terminal to be seated in the first fuse clip and the second fuse positioning structure is operable to cause the second terminal to be seated in the second fuse clip.

10. The enclosure of claim 1, wherein:
the fuse positioning structure is attached to the access door at a location that causes the fuse seat to contact a middle region of the fuse when the access door is closed;
the fuse clips comprise a first fuse clip positioned at a top of a fuse slot in the fuse housing and a second fuse clip positioned at a bottom of the fuse slot;
the terminals of the fuse comprise a first terminal and a second terminal; and
when the access door is closed, the fuse positioning structure is operable to cause the first terminal to be seated in the first fuse clip and the second terminal to be seated in the second fuse clip.

11. An enclosure, comprising:
a fuse housing configured to hold a fuse, the fuse housing comprising fuse clips operable to receive terminals of the fuse; and
a movable fuse positioning structure attached to an interior surface of the enclosure or to the fuse housing and configured to move onto and away from the fuse, the movable fuse positioning structure having a fuse seat operable to contact the fuse to cause the terminals of the fuse to be seated in the fuse clips when the fuse is inserted into the fuse housing and the movable fuse positioning structure contacts the fuse.

12. The enclosure of claim 11, wherein:
the fuse is a first fuse;
the fuse seat is a first fuse seat;
the movable fuse positioning structure includes the first fuse seat and a second fuse seat; and
one or more dimensions of the movable fuse positioning structure are based on a size and a shape of the first fuse and a size and a shape of a second fuse.

13. The enclosure of claim 11, wherein the movable fuse positioning structure includes conductive structures that are attached to the movable fuse positioning structure and configured to contact a respective fuse clip.

14. The enclosure of claim 13, wherein the conductive structure is operably connected to a monitoring device.

15. The enclosure of claim 14, wherein the monitoring device comprises a voltage monitoring device.

16. The enclosure of claim 14, wherein the monitoring device comprises a temperature monitoring device.

17. The enclosure of claim 14, wherein the monitoring device comprises an output device.

18. The enclosure of claim 14, wherein the monitoring device comprises a communication device.

19. The enclosure of claim 11, wherein:
the fuse seat is a first fuse seat;
the movable fuse positioning structure is a first movable fuse positioning structure that is configured to contact an upper region of the fuse when the first movable fuse positioning structure is in contact with the fuse;
the enclosure further comprises a second movable fuse positioning structure having a second fuse seat, the second movable fuse positioning structure attached to the interior surface of the enclosure or the fuse housing at a second location that causes the second fuse seat to contact a lower region of the fuse when the second movable fuse positioning structure is in contact with the fuse;
the fuse clips comprise a first fuse clip positioned at a top of a fuse slot of the fuse housing and a second fuse clip positioned at a bottom of the fuse slot;
the terminals of the fuse comprise a first terminal and a second terminal; and
when the first and the second fuse seats are in contact with the fuse, the first movable fuse positioning structure is operable to cause the first terminal to be seated in the first fuse clip and the second movable fuse positioning structure is operable to cause the second terminal to be seated in the second fuse clip.

20. The enclosure of claim 19, wherein:
the movable fuse positioning structure is configured to contact a middle region of the fuse when the movable fuse positioning structure is in contact with the fuse;
the fuse clips comprise a first fuse clip positioned at a top of a fuse slot in the fuse housing and a second fuse clip positioned at a bottom of the fuse slot;
the terminals of the fuse comprise a first terminal and a second terminal; and
when the fuse seat of the movable fuse positioning structure is in contact with the fuse, the movable fuse positioning structure is operable to cause the first terminal to be seated in the first fuse clip and the second terminal to be seated in the second fuse clip.
